(19) United States
(12) Patent Application Publication
(10) Pub. No.: US 2016/0375876 A1
(43) Pub. Date: Dec. 29, 2016

(54) HIGH PRESSURE AIR NOZZLE CAMERA LENS CLEANING SYSTEM

(71) Applicants: Ron Silc, Cape Coral, FL (US); Kelly Genzer, Houston, TX (US)

(72) Inventors: Ron Silc, Cape Coral, FL (US); Kelly Genzer, Houston, TX (US)

(21) Appl. No.: 15/190,670

(22) Filed: Jun. 23, 2016

Related U.S. Application Data
(60) Provisional application No. 62/184,504, filed on Jun. 25, 2015.
(60) Provisional application No. 62/353,353, filed on Jun. 22, 2016.

(51) Int. Cl. B60S 1/56; B60S 1/54

(52) U.S. Cl. CPC B60S 1/56; B60S 1/54

(57) ABSTRACT

A method, system, and apparatus comprises a housing formed to house at least one imaging device; a deflection air nozzle connected to the housing sun shield; a compressed air source; and an air nozzle activation control, wherein the air nozzle activation control regulates flow of compressed air to the deflection air nozzle in order to clear obstructions from a view of the at least one imaging device. The deflection air nozzle is mounted on a sun shield assembly associated with the housing.

### CROSS REFERENCE TO RELATED PATENT APPLICATIONS

This patent application claims the priority and benefit, under 35 U.S.C. §119(e), of U.S. provisional patent application Ser. No. 62/184,504, entitled “High Pressure Air Nozzle Camera Lens Cleaning System”, filed on Jun. 25, 2015. U.S. Provisional Patent Application Ser. No. 62/184,504 is herein incorporated herein by reference in its entirety. This patent application also claims the priority and benefit, under 35 U.S.C. §119(e), of U.S. provisional patent application Ser. No. 62/353,353, entitled “High Pressure Air Nozzle Camera Lens Cleaning System”, filed on Jun. 22, 2016. U.S. Provisional Patent Application Ser. No. 62/353,353 is herein incorporated herein by reference in its entirety.

### TECHNICAL FIELD

Embodiments are generally related to the field of cleaning or clearing a camera lens or housing. Embodiments more particularly relate to the use of high pressure air for cleaning or clearing camera lenses or housings associated with large vehicles such as trucks, buses, and other vehicles in which the camera is positioned remotely from the driver of the vehicle and out of reach from the driver.

### BACKGROUND

Mobile cameras and other video monitoring applications generally require a camera lens porthole and/or are in an environmentally sealed housing. The view from such lenses and housings are susceptible to becoming occluded when dust, moisture, and other contaminants collect on their surface. A dirty lens or housing can affect the image quality and can ultimately block the view from the camera. Thus, cameras often require manual cleaning, which is expensive and time consuming.

Current approaches to camera clearing are inadequate. In particular, certain prior art approaches use nozzles with limited air dispersal patterns. In some cases such approaches accept limited air dispersal patterns as an inherent limitation. In other cases, complicated methods may be employed to attempt to address the limited air dispersal pattern. In either case, a need exists for methods, systems, and apparatuses to automatically clean the lenses and/or housings of remote video or camera units using compressed air dispersed in adequate dispersal patterns.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method, system, and apparatus for cleaning a surface.

It is another aspect of the disclosed embodiments to provide a method, system, and apparatus for cleaning a lens or housing window associated with a video camera.

It is yet another aspect of the disclosed embodiment to clean a lens or housing window of a camera associated with a vehicle using existing compressed air provided from an air source for air brakes on the vehicle.

The aforementioned aspects and other objectives and advantages can now be achieved as described herein. An improved method, system, and apparatus for clearing an obstructed view of a camera is disclosed. Such an apparatus comprises a housing formed to house at least one imaging device; a deflection air nozzle connected to the housing; a compressed air source; and an air nozzle activation control, wherein the air nozzle activation control regulates flow of compressed air to the deflection air nozzle in order to clear obstructions from a view of the at least one imaging device. The deflection air nozzle is mounted on a sun shield assembly associated with the housing. The air deflection nozzle (such as a Lechler 686 Deflector FF Wide 1/8 NPT) comprises a threaded member formed with a voided region therein configured to allow the follow of gas and an integrated deflector knob configured to deflect air flowing out of the voided region. In another embodiment, a compressed air source comprises bleed air from a vehicle. The deflection air nozzle is configured with a seventy-five degree angle of deflection. The apparatus may further comprise at least one tubing that connects the vehicle bleed air to the nozzle.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a surface cleaning assembly in accordance with the disclosed embodiments;

FIG. 2 depicts a nozzle in accordance with the disclosed embodiments;

FIG. 3 illustrates a surface cleaning assembly in accordance with an example embodiment;

FIG. 4 depicts a mounting bracket configuration in accordance with the disclosed embodiments;

FIG. 5 depicts a system for cleaning the surface of a camera lens or housing in accordance with the disclosed embodiments;

FIG. 6 depicts a gas delivery system in accordance with disclosed embodiments;

FIG. 7 depicts a gas supply fitting in accordance with the disclosed embodiments;

FIG. 8 depicts a flow chart associated with a method for cleaning a surface in accordance with the disclosed embodiments;

FIG. 9 depicts a block diagram of a computer system which is implemented in accordance with the disclosed embodiments;

FIG. 10 depicts a graphical representation of a network of data-processing devices in which aspects of the present invention may be implemented; and

FIG. 11 illustrates a computer software system for directing the operation of the data-processing system depicted in FIG. 1, in accordance with an example embodiment.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The embodiments disclosed herein provide a simple and effective solution to remove snow, water, and road film on camera lenses for all types of vehicles equipped with air brakes. The system is designed to clean the camera with a single toggle stroke, sending compressed air onto the lens. Embodiments disclosed herein may be used to clean multiple cameras simultaneously and automatically with a microprocessor controller.

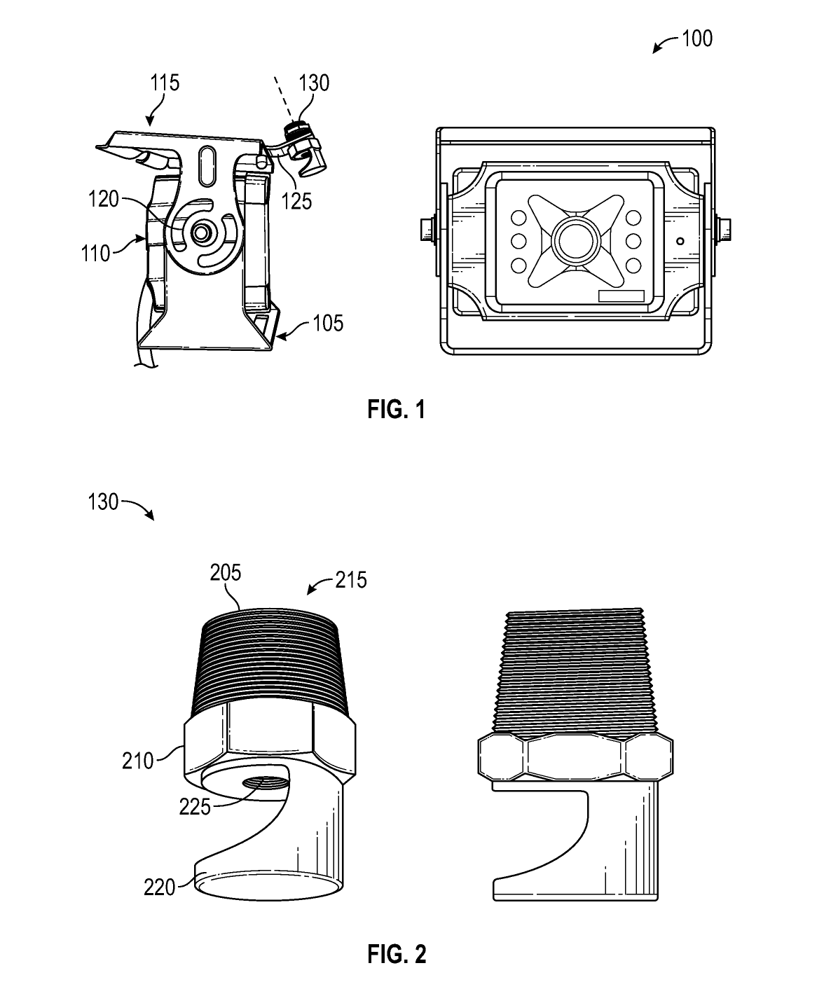

FIG. 1 illustrates a system 100 including a housing 105 for a camera 110. The housing 105 includes a sun shield 115. Sun shield 115 is configured to be rotationally mounted to housing 105 via slit and fastener assembly 120. The slit and fastener assembly 120 allows for adjustment of the angel the sun shield 115 forms with respect to the housing 105. In certain circumstances it may be advantageous to rotate the sun shield 115 to a vertical position as shown in FIG. 1. In other circumstances, the sun shield 115 can be rotated to occlude unwanted sun light or glare.

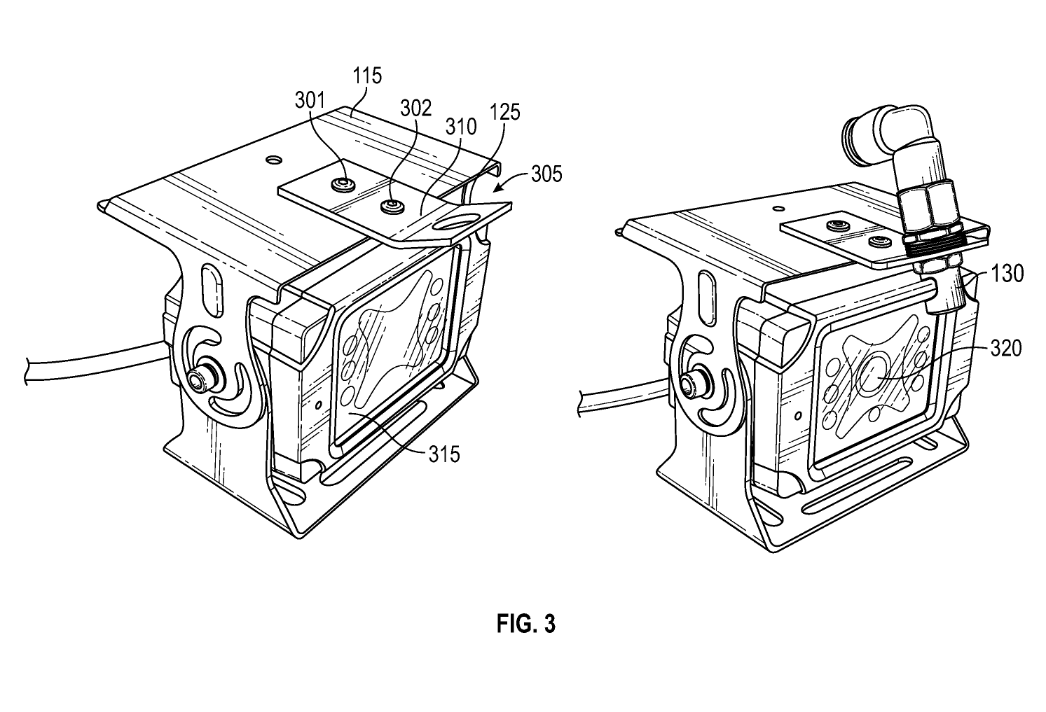

The sun shield 115 can be further configured to include a bracket 125 (also shown in FIG. 3). The bracket 125 can be mounted to the sun shield 115. Bracket 125 is configured to hold a deflection nozzle 130, which in turn is aimed toward camera 110. Deflection nozzle 130 is operably connected to tubing which allows compressed air (or other compressed gasses or liquids) to flow from a source; generally compressed gas. Most commonly this will be a vehicle's air braking system, but other sources of compressed air, gas, or fluid may also be used. Upon activation of a switch or other such mechanism, gas or liquid is released from the source and ejected out of the deflection nozzle 130 in order to remove snow, water, and other such road film or grime from the surface of the camera lens or housing.

In a preferred embodiment, the angle formed between the deflection nozzle 130 and the sun shield 115 is 28.5 degrees, although other angles are possible. The deflection nozzle is formed such that an air-releasing spout releases gas or liquid onto a deflection surface of the deflection nozzle 130. The deflection surface diverts the gas or liquid onto the lens, preferably at a PSI of 118, and at an air deflection angle of 75 degrees. These values have been experimentally evaluated to be the most effective, but other pressures and angles of deflection are also possible. It should be appreciated that all the values provided throughout the description and shown in the drawings are exemplary and are not intended to specifically limit the description herein to those values alone.

One embodiment of deflector nozzle 130 is shown in detail in FIG. 2. In a preferred embodiment, the deflector nozzle can be a Lechler 686.728.30.BA.00.0 Deflector FF WIDE 1/8″ NPT, made of brass. Other nozzles may alternatively be used. However, the air deflector 220 of the deflector nozzle 130 is critically important. In particular, in order to overcome prior art limitation related to the limited dispersal patterns, the present embodiments provide a sufficient air pattern dispersal by providing an air deflector 220 that creates a 75 degree angle of air dispersal. This angle of dispersal made possible by the air deflector 220 adequately provides the desired air dispersal pattern.

The deflector nozzle 130 can include a threaded portion 205 which further includes a voided tubular region 215. The threaded portion 205 of deflector nozzle 130 can pass through or connect to a female threaded hole in bracket 125. The hollowed region 215 allows gas or fluid to flow through the threaded portion 205. The gas or fluid can exit the hollowed region (preferably at 118 psi) at spigot 225.

A tube system which is connected to a gas or liquid supply and or valves, switches, and other devices as described herein, can be operably connected to the deflector nozzle 130. In some embodiments, a female bulkhead comprising a push-to-connect pneumatic airline NPT to OD tube can be used. The bulkhead has female threads which can connect to the threaded portion 205 of deflector nozzle 130, and can seal to the incoming tubing on the opposing end. The deflector nozzle may also include a 7/16 hex nut 210 or any other such known connecting means.

As noted above, the deflector nozzle 130 includes an air deflector 220. Air deflector 220 comprises an integrated curved interior surface, attached to the hex nut 210, which is formed to deflect outgoing gas or fluid onto the camera, camera lens, or housing surface with a sufficient dispersal pattern. As shown in FIG. 2, the angle of deflection experimentally found to provide the best dispersal pattern is 75 degrees but other deflection angles may be used depending on design considerations.

FIG. 3 illustrates a view of a sun shield 115 and a deflector nozzle 130 mounted to the sun shield 115 via bracket 125 in accordance with one embodiment of the invention. It is noteworthy that bracket 125 may include a plurality of mounting holes 301 and 302 which provide a means for connecting bracket 125 to sun shield 115. Sun shield 115 may have similar mounting holes, such that the sun shield and bracket can be joined via screws, nuts, bolts, rivets, or other such known connecting means.

FIG. 3 also illustrates view screen 315 associated with housing 105. View screen 315 is transparent thereby allowing a camera to be environmentally sealed inside housing 105, but still record images of the external environment. View screen 315 may be glass, plastic, or other such transparent material. It is important that view screen 315 integrates with housing 105 to provide an environmental seal.

In an embodiment, the screen may be periodically treated with a thin-film polymer coating. The thin-film polymer coating may be less than a micron thick. The coating is designed to provide a protective finish to the glass or plastic of the camera lens or housing. The coating prevents the adhesion of common contaminants thereby improving the efficacy of the air dispersal across the lens or housing. In some embodiments, the thin film polymer coating is free of silicon oils.

Commonly, view screen 315 may become occluded and require clearing via the methods and systems disclosed herein. In other embodiments, a view screen may not be present and the lens 320 of the camera may be cleared via the methods and systems disclosed herein. In such cases the deflector nozzle 130 may be configured to more readily provide gas or liquid to the specific location of the lens 320 as opposed to the view screen 315.

Bracket 125 further includes female threaded mounting hole 305 for mounting deflector nozzle 130. In the embodiment illustrated in FIG. 3, the deflector nozzle 130 is fastened through mounting hole 305 with a nut affixed to deflector nozzle 130. In other embodiments, means of connecting the deflector nozzle may equivalently be used and mounting hole 305 may not included female threads.

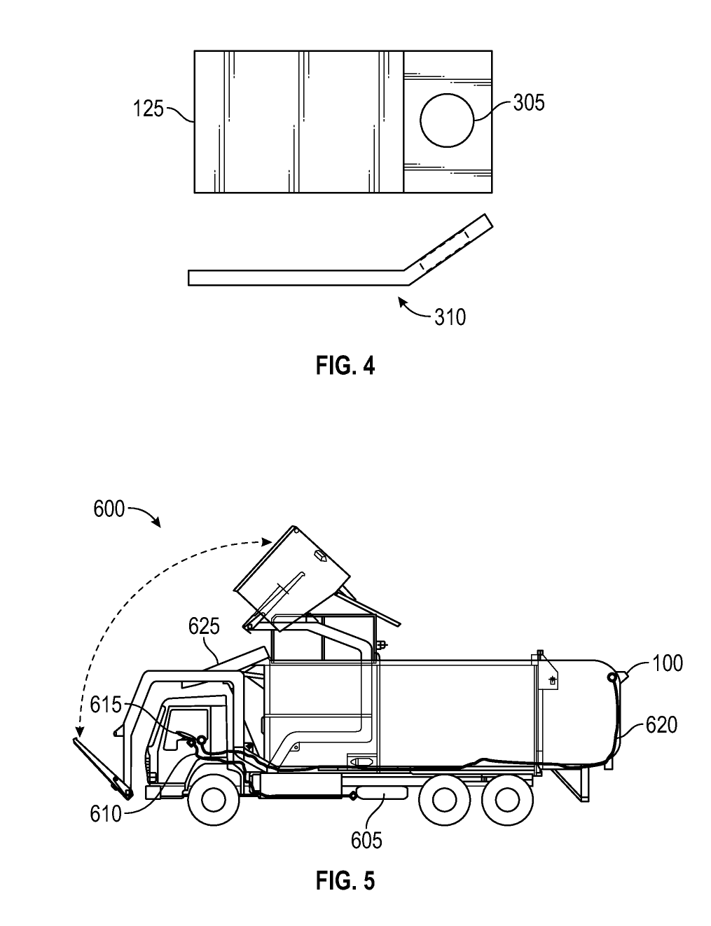

Bracket 125 may optionally be bent slightly at bend 310 away from the mounting surface of sun shield 115 to facilitate the proper angle of air release. As shown in FIG. 4, preferable dimensions of the bracket may be 1 inch by 2⅛ inches, the mounting hole 305 may be 13/32 s, bend 310 may be made ⅝ inches from the end of the bracket and may be bent at 28.5 degrees. It should be appreciated that these dimensions have been verified to provide optimal debris removal from screen 315. However, other dimensions might be equivalently employed depending on design considerations.

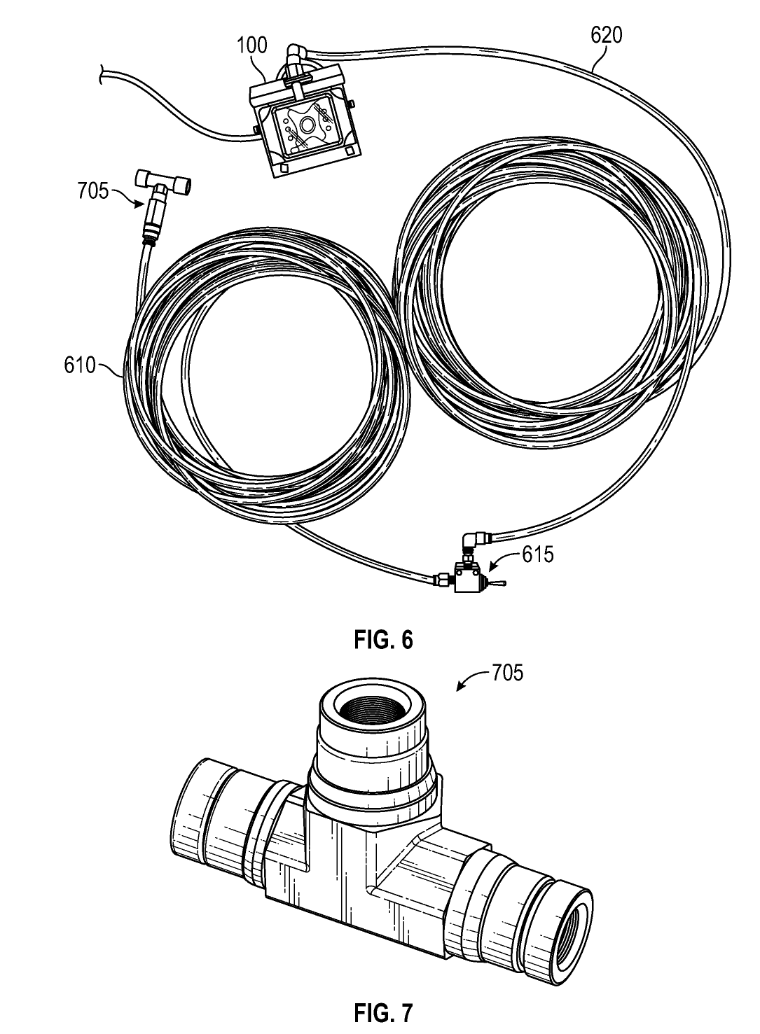

FIG. 5 illustrates an embodiment 600 of the invention associated with a truck 625. It should be understood that the truck shown in this embodiment is intended only for illustrative purposes. The embodiments disclosed herein could be equivalently used with any vehicle including airplanes, boats, trains, or other land based vehicles, provided that the vehicle is equipped with, or otherwise is fitted with a source of compressed gas or liquid. In alternative embodiments, a compressed air source may be added to the vehicle if necessary.

In FIG. 5, truck 625 has compressed air source 605. This compressed air source 605 could be embodied as a standalone air compression and storage device, but is preferably supplied by air brakes associated with truck 625. In other embodiments, air source 605 may be embodied as a source of some other gas or liquid.

A fitting 705 (shown in FIG. 7) can connect the compressed air source 605 to tubing 610. Tubing 610 delivers the compressed air from the compressed air source 605 to the control valve and air nozzle activation control 615 (further detail provided in FIG. 6). The control valve and air nozzle activation control 615 allows a user, commonly an operator of the vehicle 625, to release air from tube 610 to tube 620. This may be accomplished with a switch and valve assembly or other such arrangement.

In other embodiments, the control valve and air nozzle activation control may be activated remotely via wireless or other data communications networks. The activation may be achieved automatically or via some other observer, such as a person monitoring data being received from camera 110. In another embodiment, air nozzle activation control 615 may remotely activate a valve located anywhere along tubing 620. The signal may come from wired or wireless communication between the air nozzle activation control 615 and the valve.

Upon operation of the air nozzle activation control 615, air flows through tube 620 to system 100 wherein a blast of air (or other such gas or liquid) is expelled through deflector nozzle 130 thereby clearing the surface of camera 110, camera lens 320, or housing 105.

FIG. 6 illustrates a distribution assembly associated with the embodiments disclosed herein. An air supply fitting 705 is shown connected to tubing 610. Tubing 610 can be one quarter inch polyurethane air line tubing. Other such tubing may alternatively be used. It should be appreciated that air supply fitting 705 may be embodied as any suitable connection to compressed air source 605. In this embodiment, the air supply fitting 705 is configured to integrate with an air brake apparatus for a vehicle such as vehicle 625.

Tubing 610 is shown connected with air nozzle activation control 615. Two embodiments of air nozzle activation control 615 are possible. The first embodiment is a momentary toggle as shown in FIG. 6. The other can be a microprocessor-controlled valve that automatically activates the airflow. Such a microprocessor may be integrated in air nozzle activation control 615 or may be embodied as a stand-alone computer, smartphone, hand-held device, or other such microprocessor based device, connected to said air nozzle activation control via wired or wireless communication. It should be appreciated that other switches and controls could alternatively be used. Air nozzle activation control 615 is further connected with tubing 620 which in turn is connected to the apparatus 100 for clearing a camera lens.

FIG. 7 illustrates an exploded view of a truck air supply fitting branch T, which is an exemplary embodiment of fitting 705 for connecting tubing 610 to an air supply. The fitting may comprise a compression fitting on one or more of the air path exits. The fitting 705 may be brass or other such suitable material.

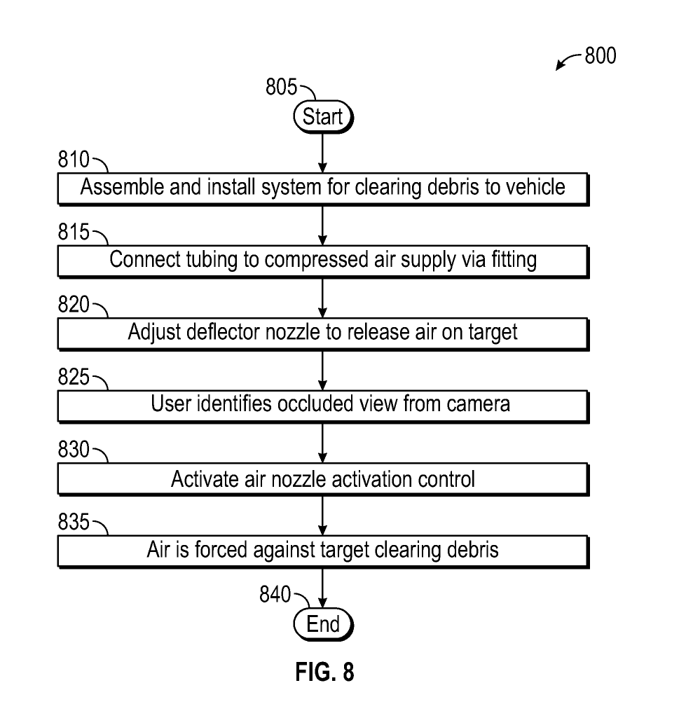

FIG. 8 illustrates a flow chart 800 of steps associated with a method for clearing debris or other material, occluding the view of a camera, from the lens or housing of the camera. The method begins at step 805. At step 810, the systems or apparatuses disclosed herein, including those illustrated in FIGS. 1-7 can be assembled and installed on the desired vehicle. At step 815, the tubing can be connected to a compressed air supply (preferably an air brake system) via a fitting. Next, the deflector nozzle can be adjusted to ensure the air released from the nozzle is directed at the face of the camera lens or housing at step 820. It is now incumbent on the user to review the view from the imaging device and determine if the occlusion from debris requires removal at step 825. Note in an alternative embodiment, the determination of whether the view requires clearing may be done automatically by a computer, or by an external observer. At step 830, the air nozzle activation control can be activated, thereby allowing gas or liquid to flow from the compressed air source through the tubing and out the deflector nozzle as shown at step 835. Note in alternative embodiments, this step may be initiated by a user or initiated automatically, either according to the determination at step 825 or at scheduled intervals by a computing device. The method ends at step 840.

It should be noted that in certain embodiments of the method a thin-film polymer coating may be periodically applied to the camera lens or housing surface. In an embodiment, the coating can be applied to the camera lens or housing surface after it has been cleaned and dried. The thin-film polymer coating is allowed to dry to a haze at which point excess material can be wiped from the camera lens or housing. The thin-film polymer coating is then left to cure out of contaminating environmental conditions for 12 hours. The coating may be preferably reapplied at an interval of 4-6 months, but other intervals may be acceptable depending on environmental conditions.

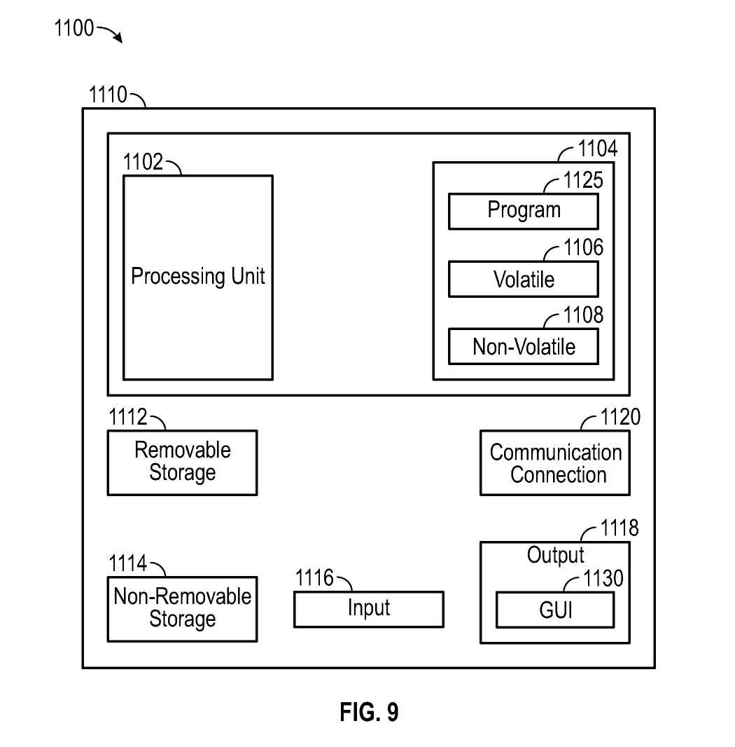

FIGS. 9-11 are provided as exemplary diagrams of data-processing environments in which embodiments of the present invention may be implemented. It should be appreciated that FIGS. 9-11 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 1100 that executes programming for implementing the methods and systems disclosed herein is shown in FIG. 9. A general computing device in the form of a computer 1110 may include a processing unit 1102, memory 1104, removable storage 1112, and non-removable storage 1114. Memory 1104 may include volatile memory 1106 and non-volatile memory 1108. Computer 1110 may include or have access to a computing environment that includes a variety of transitory and non-transitory computer-readable media such as volatile memory 1106 and non-volatile memory 1108, removable storage 1112 and non-removable storage 1114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data.

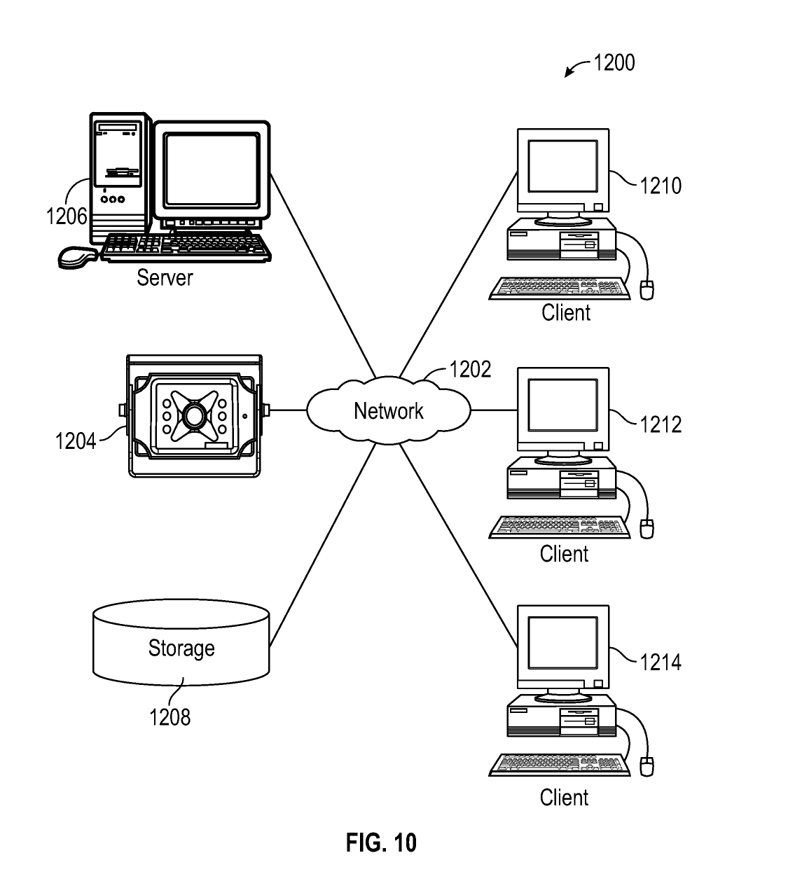

Computer 1110 may include or have access to a computing environment that includes input 1116, output 1118, and a communication connection 1120. The computer may operate in a networked environment using a communication connection to connect to one or more remote computers or devices. The remote computer may include a personal computer (PC), server, router, network PC, a peer device or other common network node, camera, video recording device, toggling device, or the like. The communication connection may include a Local Area Network (LAN), a Wide Area Network (WAN), or other networks. This functionality is described in more fully in the description associated with FIG. 10 below.

Output 1118 is most commonly provided as a computer monitor, but may include any visual output device. Output 1118 may also include a data collection apparatus associated with computer system 1100. In addition, input 1116, which commonly includes a computer keyboard and/or pointing device such as a computer mouse, computer track pad, or the like, allows a user to select and instruct computer system 1100. A user interface can be provided using output 1118 and input 1116. Output 1118 may function as a display for displaying data and information for a user and for interactively displaying a graphical user interface (GUI) 1130.

Note that the term “GUI” generally refers to a type of environment that represents programs, files, options, and so forth by means of graphically displayed icons, menus; and dialog boxes on a computer monitor screen. A user can interact with the GUI to select and activate such options by directly touching the screen and/or pointing and clicking with a user input device 1116 such as, for example, a pointing device such as a mouse, and/or with a keyboard. A particular item can function in the same manner to the user in all applications because the GUI provides standard software routines (e.g., module 1125) to handle these elements and report the user's actions.

Computer-readable instructions, for example, program module 1125, which can be representative of other modules described herein, are stored on a computer-readable medium and are executable by the processing unit 1102 of computer 1110. Program module 1125 may include a computer application. A hard drive, CD-ROM, RAM, Flash Memory, and a USB drive are just some examples of articles including a computer-readable medium.

FIG. 10 depicts a graphical representation of a network of data-processing systems 1200 in which aspects of the present invention may be implemented. Network data-processing system 1200 is a network of computers in which embodiments of the present invention may be implemented. Note that the system 1200 can be implemented in the context of a software module such as program module 1125. The system 1200 includes a network 1202 in communication with one or more clients 1210, 1212, and 1214. Network 1202 is a medium that can be used to provide communications links between various devices and computers connected together within a networked data processing system such as computer system 1100. Network 1202 may include connections such as wired communication links, wireless communication links such as cloud based connection, or fiber optic cables. Network 1202 can further communicate with one or more servers 1206, one or more video cameras or other such peripheral devices 1204 and a memory storage unit such as, for example, memory or database 1208.

In the depicted example, video camera 1204 (and/or deflector nozzle 130) and server 1206 connect to network 1202 along with storage unit 1208. In addition, clients 1210, 1212, and 1214 connect to network 1202. These clients 1210, 1212, and 1214 may be, for example, personal computers or network computers. Computer system 1100 depicted in FIG. 10 can be, for example, a client such as client 1210, 1212, and/or 1214.

Computer system 1100 can also be implemented as a server such as server 1206, depending upon design considerations. In the depicted example, server 1206 provides data such as boot files, operating system images, applications, and application updates to clients 1210, 1212, and 1214, and peripheral devices such as camera 1204. Clients 1210, 1212, and 1214, and peripheral devices such as camera 1204 may be clients to server 1206 in this example. Network data-processing system 1200 may include additional servers, clients, and other devices not shown. Specifically, clients may connect to any member of a network of servers, which provide equivalent content.

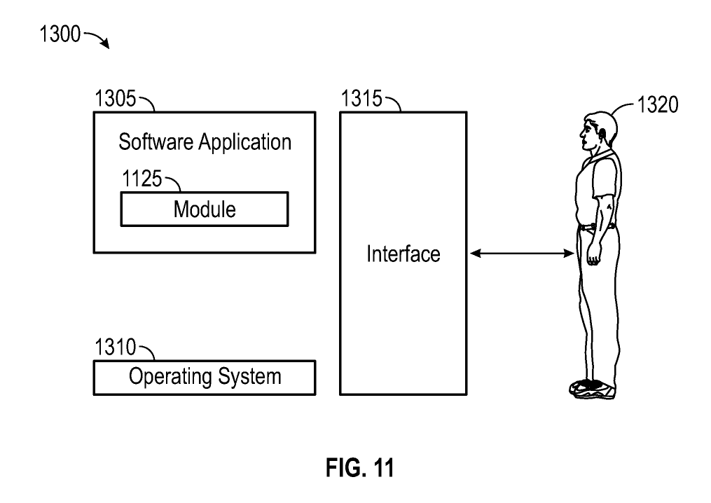

In the depicted example, network data-processing system 1200 is the Internet with network 1202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 1200 may also be implemented as a number of different types of networks such as, for example, an intranet, a local area network (LAN), or a wide area network (WAN). FIGS. 10 and 11 are intended as examples and not as architectural limitations for different embodiments of the present invention.

FIG. 11 illustrates a computer software system 1300, which may be employed for directing the operation of the data-processing systems such as computer system 1100 depicted in FIG. 9. Software application 1305, may be stored in memory 1104, on removable storage 1112, or on non-removable storage 1114 shown in FIG. 9, and generally includes and/or is associated with a kernel or operating system 1310 and a shell or interface 1315. One or more application programs, such as module(s) 1125, may be “loaded” (i.e., transferred from removable storage 1114 into the memory 1104) for execution by the data-processing system 1100. The data-processing system 1100 can receive user commands and data through user interface 1315, which can include input 1116 and output 1118, accessible by a user 1320. These inputs may then be acted upon by the computer system 1100 in accordance with instructions from operating system 1310 and/or software application 1305 and any software module(s) 1125 thereof.

Generally, program modules (e.g., module 1125) can include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, load origination, loan risk analysis, etc.

In embodiments of the invention, the computing environments disclosed in FIGS. 9-11 may be used to implement automated releases of air to one or many systems such as system 100. In these embodiments, a computer such as computer 100 may be programmed with a program module 125, which may comprise non-transitory instruction media, to automatically determine if the lens of camera 110 or housing 105 is occluded and automatically direct that the system be used to clean the occluded lens or housing. Alternatively, the computer system 100 may be integrated and/or associated with air nozzle activation control 615 and programmed to automatically release air via one or more systems 100 on preset intervals. These intervals may be set by a user or may be determined by the system automatically.

Benefits associated with the embodiments disclosed herein include, but are not limited to low maintenance, easy operation on truck air systems, does not require refill of washing solutions, mounts on camera shroud or other such housing, does not require (but may include) adhesives to mount nozzle, provides instant toggle demand operation, may optionally provide automated operation, and keeps vehicle related cameras clear of road film and debris.

Based on the foregoing, it can be appreciated that a number of embodiments, preferred and alternative, are disclosed herein. For example, in one embodiment, an apparatus comprises a housing formed to house at least one imaging device; a deflection air nozzle connected to the housing; a compressed air source; and an air nozzle activation control, wherein the air nozzle activation control regulates flow of compressed air to the deflection air nozzle in order to clear obstructions from a view of the at least one imaging device. The deflection air nozzle is mounted on a sun shield assembly associated with the housing. Note that camera housings associated with the embodiments described herein may be designed with the nozzle thread for the Lechler 686 incorporated within the housing.

In another embodiment the air deflection nozzle comprises a threaded member formed with a voided region therein configured to allow the follow of gas and an integrated deflector knob configured to deflect air flowing out of the voided region. In another embodiment, compressed air source comprises bleed air from a vehicle.

In an alternative embodiment, the deflection air nozzle is configured with a seventy-five degree angle of deflection. The apparatus may further comprise at least one tubing that connects the vehicle bleed air to the air burst nozzle.

In an alternative embodiment, a method of clearing obstructions from a view of an imaging device, comprises providing compressed air to a deflection air nozzle; operating an air nozzle activation control to release the compressed air to the deflection air nozzle; and directing a burst of air from the deflection air nozzle at a housing formed to house at least one imaging device in order to clear obstructions from a view of the at least one imaging device. The air deflection nozzle comprises a threaded member formed with a voided region therein configured to allow the flow of gas and an integrated deflector knob configured to deflect air flowing out of the voided region.

In one embodiment, the compressed air source comprises bleed air from a vehicle. The deflection air nozzle is configured with a seventy-five degree angle of deflection. The method may further comprise providing the bleed air to the air burst nozzle with at least one tubing that connects the vehicle bleed air to the air burst nozzle.

In another embodiment, a system comprises a housing formed to house at least one imaging device, a deflection air nozzle connected to the housing, a compressed air source, and an air nozzle activation control, wherein the air nozzle activation control regulates flow of gas to the deflection air nozzle in order to clear obstructions from a view of the at least one imaging device. In an embodiment, the deflection air nozzle is mounted on a sun shield assembly associated with the housing.

In an embodiment, the air deflection nozzle comprises a threaded member formed with a voided region therein configured to allow the follow of gas and an integrated deflector knob configured to deflect air flowing out of the voided region. In an embodiment, the compressed air source comprises bleed air from a vehicle and the deflection air nozzle is configured with a seventy-five degree angle of deflection.

In an embodiment, tubing that connects the vehicle bleed air to the air burst nozzle. In an embodiment, the air activation automatically releases gas in a controlled sequence and automatically releases air to each of a plurality imaging devices simultaneously.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. An apparatus comprising:
a housing formed to house at least one imaging device;
a deflection air nozzle connected to said housing;
a gas source; and
an air nozzle activation control, wherein said air nozzle activation control regulates flow of gas to said deflection air nozzle in order to clear obstructions from a view of said at least one imaging device.

2. The apparatus of claim 1 wherein said deflection air nozzle is mounted on a sun shield assembly associated with said housing.

3. The apparatus of claim 1 wherein said air deflection nozzle comprises a threaded member formed with a voided region therein configured to allow the flow of gas and an integrated deflector knob configured to deflect air flowing out of said voided region.

4. The apparatus of claim 1 wherein said gas source comprises bleed air from a vehicle.

5. The apparatus of claim 2 wherein said deflection air nozzle is configured with a seventy-five degree angle of deflection.

6. The apparatus of claim 1 further comprising at least one tubing that connects said vehicle bleed air to said air burst nozzle.

7. A method of clearing obstructions from a view of an imaging device, comprising:
providing compressed gas to a deflection air nozzle;
operating an air nozzle activation control to release said compressed gas to said deflection air nozzle; and
directing a burst of gas from said deflection air nozzle at a housing formed to house at least one imaging device in order to clear obstructions from a view of said at least one imaging device.

8. The method of claim 7 wherein said air deflection nozzle comprises a threaded member formed with a voided region therein configured to allow the flow of gas and an integrated deflector knob configured to deflect air flowing out of said voided region.

9. The method of claim 7 wherein said compressed gas source comprises bleed air from a vehicle.

10. The method of claim 8 wherein said deflection air nozzle is configured with a seventy-five degree angle of deflection.

11. The method of claim 7 further comprising providing said bleed air to said air burst nozzle with at least one tubing that connects said vehicle bleed air to said air burst nozzle.

12. The method of claim 8 wherein said at least one imaging device comprises a plurality of imaging devices.

13. The method of claim 12 further comprising automatically clearing each of said imaging devices in a controlled sequence.

14. A system comprising:
a housing formed to house at least one imaging device:
a deflection air nozzle connected to said housing;
a compressed air source; and
an air nozzle activation control, wherein said air nozzle activation control regulates flow of gas to said deflection air nozzle in order to clear obstructions from a view of said at least one imaging device.

15. The system of claim 14 wherein said deflection air nozzle is mounted on a sun shield assembly associated with said housing.

16. The system of claim 14 wherein said air deflection nozzle comprises a threaded member formed with a voided region therein configured to allow the follow of gas and an integrated deflector knob configured to deflect air flowing out of said voided region.

17. The system of claim 14 wherein said compressed air source comprises bleed air from a vehicle.

18. The system of claim 15 wherein said deflection air nozzle is configured with a seventy-five degree angle of deflection.

19. The system of claim 14 further comprising at ea one tubing that connects said vehicle bleed air to said air burst nozzle.

20. The system of claim 14 wherein said air activation automatically releases gas in a controlled sequence.
